(19) United States
(12) Patent Application Publication
(10) Pub. No.: US 2011/0197573 A1
(43) Pub. Date: Aug. 18, 2011

(54) DEVICE FOR COMPENSATING FOR HYDRAULIC EFFECTIVE PRESSURES

(76) Inventor: Rüdiger Honsbein, Lebach-Dorsdorf (DE)

(21) Appl. No.: 12/998,341

(22) PCT Filed: Oct. 16, 2009
(86) PCT No.: PCT/EP2009/007422

§ 371 Date: Apr. 11, 2011

(30) Foreign Application Priority Data
Nov. 7, 2008 (DE) 10 2008 057 723.5

(51) Int. Cl. F16D 31/02

(52) U.S. Cl. 60/413

(57) ABSTRACT

The invention relates to a device for compensating for hydraulic effective pressures in a hydraulic accumulator (9) and a hydraulic actuator (5) of a hydraulic system (11, 13) having a valve arrangement (27) for blocking a connection between the hydraulic actuator (5) and hydraulic accumulator (9) and having a control valve device (11) performing a pressure compensation when a predetermined difference in effective pressures is exceeded.

The invention relates to a device for compensating for hydraulic effective pressures in a hydraulic accumulator and a hydraulic actuator of a hydraulic system.

In hydraulic systems in which hydraulic actuators are used, for example, for support or lifting systems, it is prior art to use hydraulic accumulators as spring or damper elements that are hydraulically coupled to the actuator for cushioning or attenuating the movements of components which are moved by the hydraulic actuator. In some operating situations of such systems, however, an uncushioned, rigid dynamic connection between the actuator and the device actuated by it is necessary, for example, if it is a hydraulically actuated boom which is intended to form a rigid support element, or a tool which is to be controlled vibration-free when in use. In view of these requirements, the connection between the pertinent actuator and the hydraulic accumulator must be blocked.

In operation with the spring system blocked, the effective pressure in the hydraulic actuator changes according to the performance to be delivered by it. If at this point the system is transferred from the state of the blocked spring system back into the state with the hydraulic accumulator connected, a difference in the effective pressure between the hydraulic accumulator and the actuator leads to uncontrolled motion at the actuator; this poses a hazard to the system and a safety risk for system operators.

In light of the foregoing, the object of the invention is to provide a device which prevents this safety risk.

This object is achieved according to the invention by a pressure compensation device which has the features of claim 1 in its entirety.

Accordingly, it is provided according to the invention that the valve arrangement which blocks the connection between the hydraulic actuator and the hydraulic accumulator has an additional control valve means which effects pressure compensation when a predetermined difference of the effective pressures is exceeded. This avoids the risk of uncontrolled motion when the system is transferred from the state of the blocked spring system into the state with the spring system released, because the respective effective pressures of the hydraulic accumulator and of the hydraulic actuator are matched to one another.

If, in the state of the blocked spring system, the pressure which is effective in the hydraulic accumulator is less than the effective pressure given in the respective working situation in the hydraulic actuator, pressure compensation can easily take place in the conventional manner by the hydraulic actuator charging the hydraulic accumulator via a non-return valve up to a constant pressure, with the non-return valve closing when the pressure is equal.

The particular advantage of the invention, however, consists in that, when a higher pressure prevails in the hydraulic accumulator, this pressure is reduced by pressure drainage toward the tank side of the hydraulic system.

According to especially advantageous exemplary embodiments, for this purpose the arrangement is such that the valve arrangement has a directional valve which in its release state establishes a direct fluid connection between the hydraulic actuator and the hydraulic accumulator and interrupts this fluid connection in its blocked state, wherein the control valve means can be activated depending on the transfer of the directional valve into the blocked state and contains a drainage valve which can be controlled by a difference of effective pressures that exceeds the preset value into its release state in which a drainage path that reduces the pressure difference toward the tank side of the hydraulic system is formed. This ensures that the equalization of the effective pressures takes place not only by charging of the hydraulic accumulator, but that charging of the hydraulic accumulator can take place only up to a pressure level at which the prescribed pressure difference is not exceeded because when this pressure difference is reached, pressure compensation takes place via the drainage valve toward the tank side of the system.

In one preferred application of the invention, the hydraulic actuator is at least one lifting cylinder of a machine whose piston side which produces the lifting force and whose rod side are connected to a control block of the machine, the piston side of the lifting cylinder being connectable via the directional valve to the hydraulic accumulator and the control valve means having a connection to the hydraulic accumulator and fluid paths to the piston side and to the rod side of the lifting cylinder, which two fluid paths contain non-return valves which clear the fluid path only to the side of the lifting cylinder that carries the higher effective pressure.

In an especially advantageous manner, the arrangement can be such that there is a drainage valve in the form of a pressure compensator which in the release state clears the drainage path toward the tank side from the connection to the hydraulic accumulator and from the fluid path which has been cleared in each case and which leads to the lifting cylinder.

In order to avoid generating noise or causing damage to the hydraulic accumulator, the arrangement can be made such that the drainage process takes place from the accumulator to the tank side only when the pressure difference is somewhat greater than zero. At the same time, preloading which intensifies the action of the closing pressure can be active on the pressure compensator.

In especially advantageous exemplary embodiments, the pressure compensator has a slide valve piston which, for its displacement into the blocking position on one piston area, can be loaded both with the closing pressure from the hydraulic working circuit and is also loaded with the force of a preload spring.

The invention is detailed below using an exemplary embodiment illustrated in the drawings.

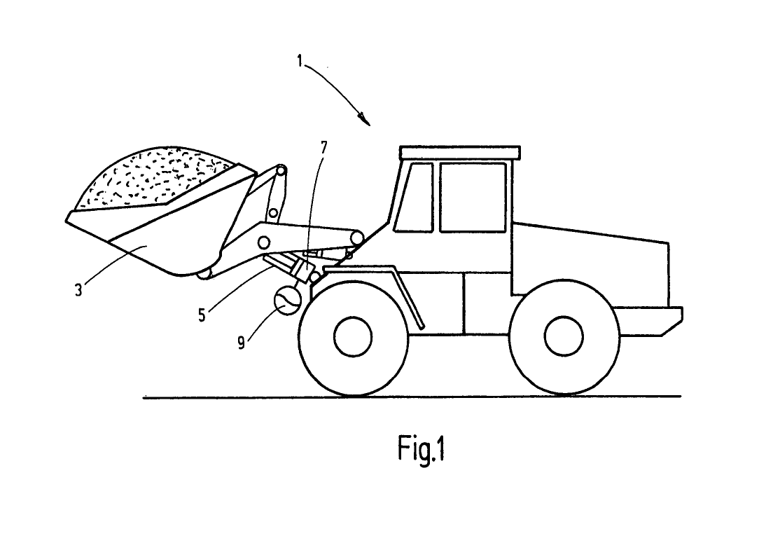

FIG. 1 shows a schematically simplified side view of a mobile machine in the form of a wheel loader, equipped with one exemplary embodiment of the device according to the invention;

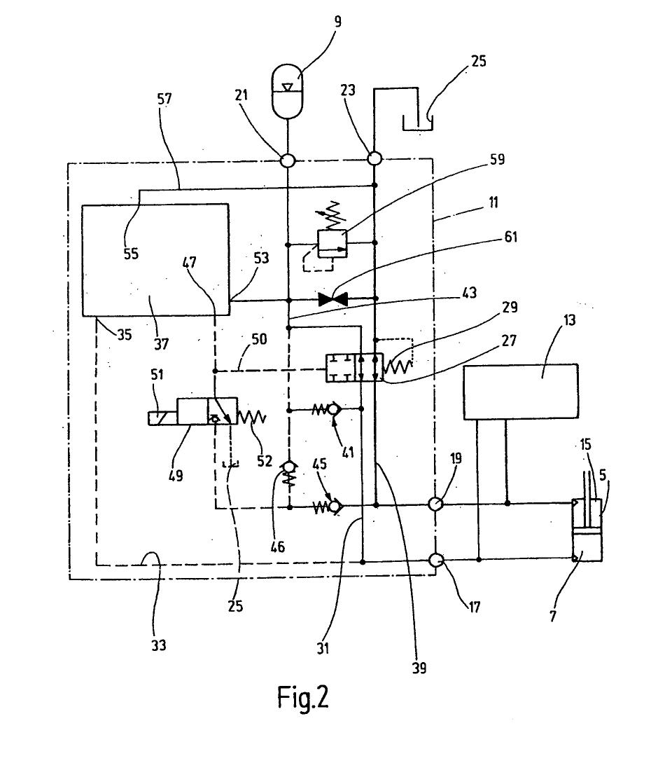

FIG. 2 shows a symbolic representation of the circuit of the hydraulic system of the exemplary embodiment of the device according to the invention, shown in the operating state with the spring system released;

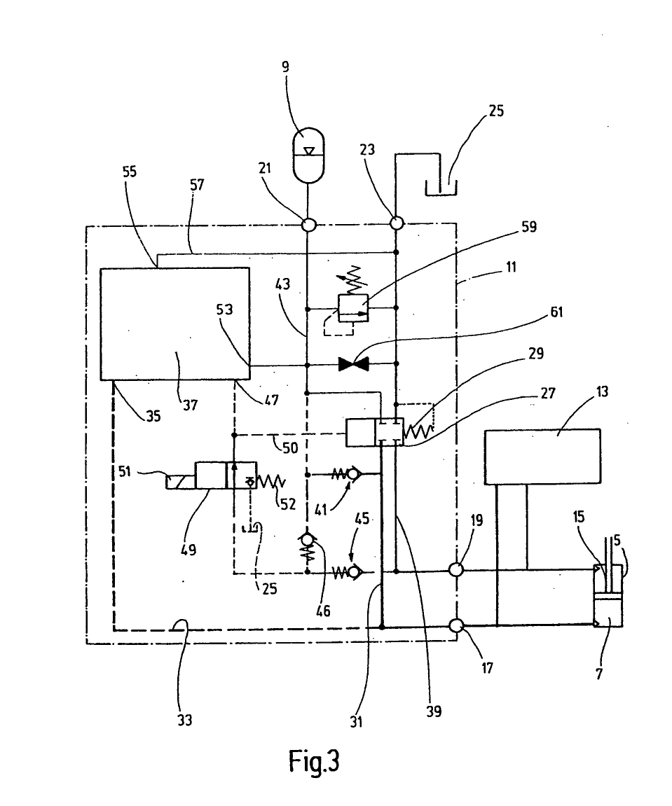

FIG. 3 shows a representation corresponding to FIG. 2, with the operating state being shown with an effective pressure in the hydraulic accumulator that is smaller than the effective pressure on the piston side of the lifting cylinder;

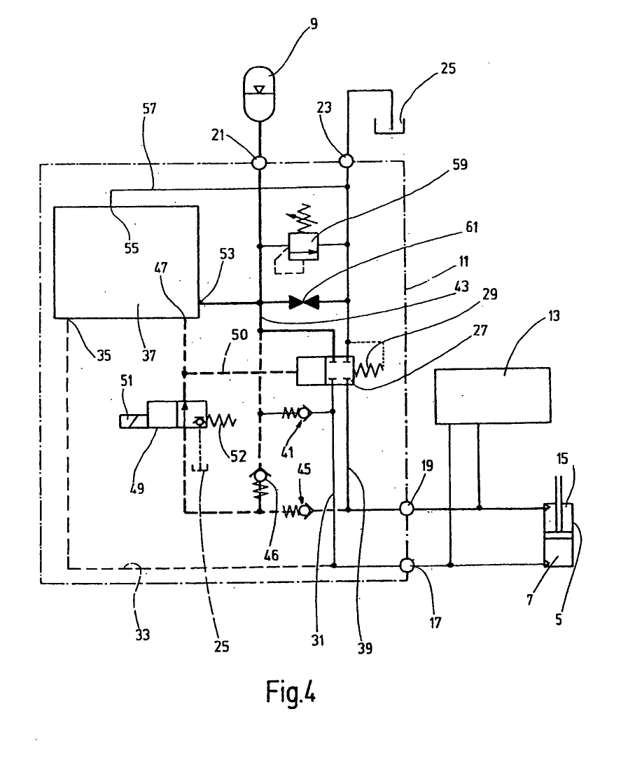

FIG. 4 shows a corresponding representation, with the effective pressure in the accumulator being greater than on the piston side of the lifting cylinder;

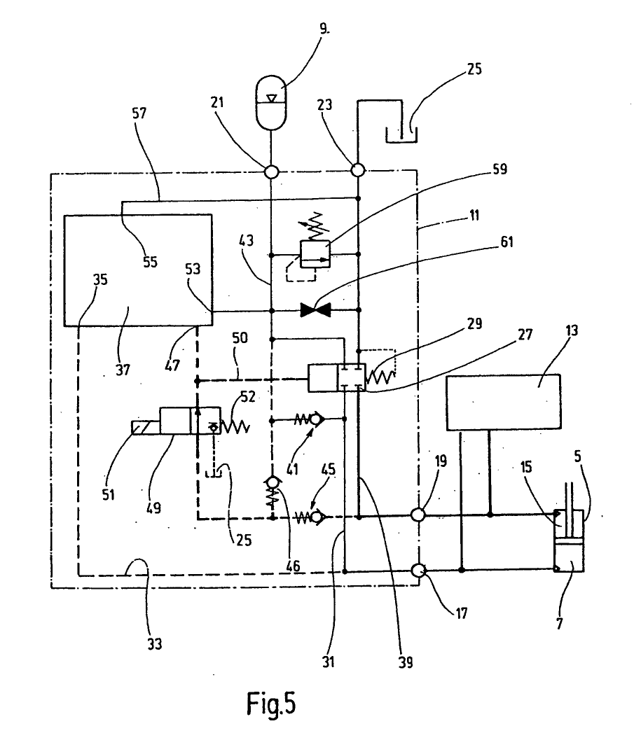

FIG. 5 shows a corresponding representation in which the effective pressure on the rod side of the lifting cylinder is greater than on the piston side or in the hydraulic accumulator;

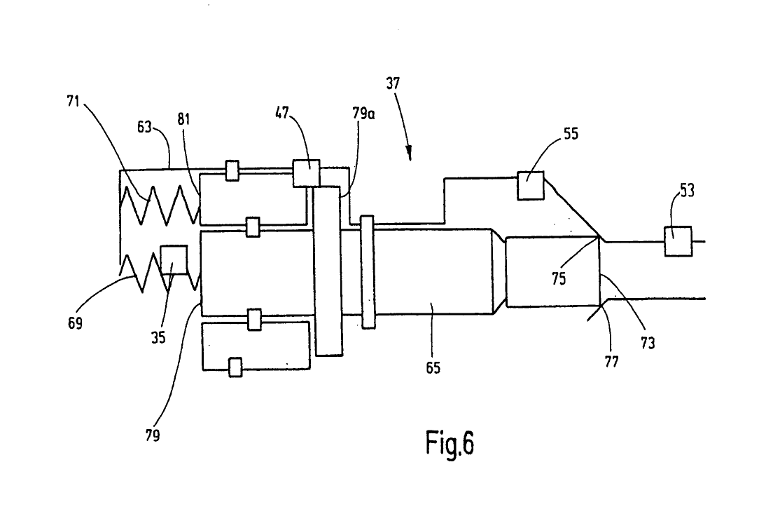

FIG. 6 shows a functional sketch of a pressure compensator which serves as a drainage valve of the exemplary embodiment;

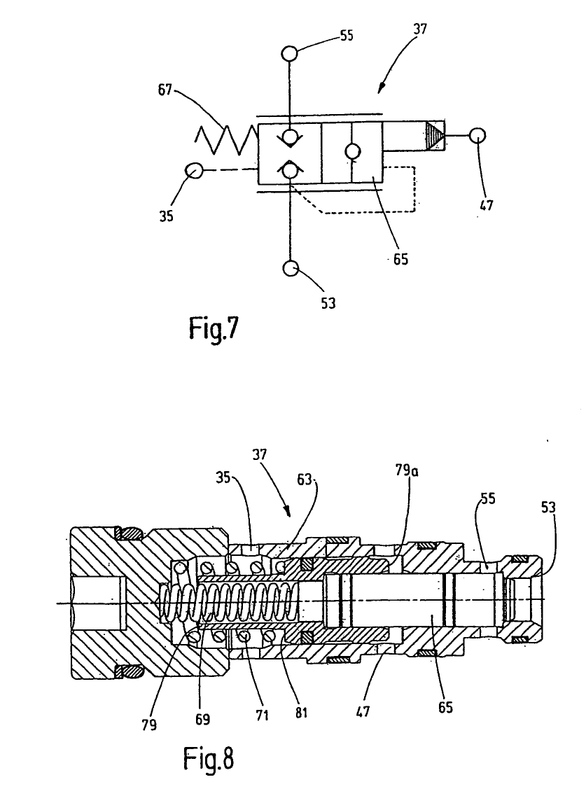

FIG. 7 shows a symbolic representation of the pressure compensator from FIG. 6, and

FIG. 8 shows a longitudinal section of a spool valve which serves as a pressure compensator and which can be inserted into a valve block which is not shown.

FIG. 1 shows a mobile machine in the form of a wheel loader 1 to whose shovel 3 a lifting cylinder 5 is coupled. The latter cylinder forms the hydraulic actuator of the exemplary embodiment of the device according to the invention to be described here. Accordingly, the piston side 7 of the lifting cylinder 5 which produces the lifting force for the shovel 3 when pressure is supplied is connected to a hydraulic accumulator 9, indicated only symbolically in FIG. 1, via the hydraulic components which are not illustrated in FIG. 1.

FIGS. 2 to 5 in a symbolic representation show the circuit of the hydraulic system in different operating states. FIG. 2 shows the state with the spring system released. A control block 13 of the machine (wheel loader 1) with a pressure supply means, not shown, for controlled supply of the lifting cylinder 5 is connected to its piston side 7 and its rod side 15. A valve arrangement 11 which forms the principal part of the hydraulic system has inputs 17 and 19 to which the piston side 7 and the rod side 15 of the lifting cylinder 5 are connected respectively. The hydraulic accumulator 9 and the tank 25 of the hydraulic system are connected to the outputs 21 and 23 of the valve arrangement 11.

As mentioned, FIG. 2 shows the state of the released spring system. Here a directional valve 27 is in its release state as a result of its mechanical spring preload 29, the piston side 7 on the port 17 being connected directly to the hydraulic accumulator 9 at the output 21 and the rod side 15 of the lifting cylinder 5 being connected via the input 19 directly to the tank 25 at the output 23. In this operating state, the other hydraulic components are not involved in the operating process; i.e., the system effects a conventional cushioning/damping of the activity of the lifting cylinder 5.

As mentioned, in certain operating situations a spring system is not useful or is detrimental. When a shovel 3 of a loader 1 is actuated, for example, spring compression or rebound has a negative effect on the accuracy of the positioning of the shovel 3. The system is transferred into the state of the blocked spring system such that, by supplying a hydraulic control pressure via a control line 50, the directional valve 27 is moved into the blocking state against the preload 29; this is detailed below.

FIGS. 3 to 5 illustrate three different operating modes for the spring system blocked in each case. Here, FIG. 3 refers to the state in which on the piston side 7 of the lifting cylinder 5 a higher effective pressure prevails than in the hydraulic accumulator 9, as dictated by operation. Accordingly, FIG. 3 shows with the thicker line the fluid connections which carry the higher pressure, specifically from the input 17 of the valve arrangement 11 to the blocked directional valve 27 via a line branch 31 and branching from the line branch 31 via a closing pressure control line 33 shown by the thick line to a control port 35 of a drainage valve 37. This control port 35 here is designated as the second control port. Corresponding to the effective pressure which prevails in the line branch 31 and which is higher than that in the line branch 39 indicated by the thin line at the input 19 and on the rod side 15 of the lifting cylinder 5, a non-return valve 41 which is connected to the line branch 31 is opened so that the accumulator 9 at the output 21 is charged to the pressure of the piston side 7 via an accumulator line 43. In this state, the non-return valve 45, which is connected between the accumulator line 43 and input 19 in the same direction as the initially mentioned non-return valve 41, is closed. This arrangement of the non-return valves 41 and 45 causes the higher effective pressure from the inputs 17 and 19 to take effect in the system via a respective fluid path which is formed by opening of one or another non-return valve. Furthermore, in the connecting line to the accumulator 9 between the two port sites of the non-return valves 41 and 45 another non-return valve 46 is connected which, oriented toward the accumulator 9, moves into its pertinent closed position.

Another control port 47 of the drainage valve 37, which is referred to as the first control port here, is connected via a control valve 49, when it is in its opening state shown in FIG. 3, to the accumulator line 43 which in turn is connected to the input 17 or the input 19 corresponding to one or another fluid path, i.e., depending on which of the non-return valves 41 or 45 is opened. In the state shown in FIG. 3, this is the fluid path which leads via the non-return valve 41 to the input 17, which carries the higher effective pressure. The pressure which prevails on the first control port 47 via the opened control valve 49 also serves as a hydraulic control pressure which hydraulically transfers the directional valve 27, which is preloaded into the opening state by its spring preload 29, into the closed state shown in FIG. 3 and thus moves the entire system into the state of the blocked spring system.

With the released spring system in the state mentioned above in FIG. 2, the control valve 49 is in its closed state, which is caused by its actuating magnet 51 being energized so that the valve 49 is closed against its opening spring 52. In this way, in the state of the released spring system, the first control port 47 of the drainage valve 37, and the control line 50 of the directional valve 27, are depressurized by connecting to the tank side 25. The preload 29 therefore keeps the directional valve 27 in its opening state. If the power to the actuating magnet 51 is interrupted and the control valve 49 is opened, the directional valve 27 is hydraulically directed against its preload 29 into the blocked state via the control line 50, and the system passes into the state of the blocked spring system, as is shown in FIGS. 3 to 5.

In the state shown in FIG. 3, in which the higher effective pressure which prevails in the line branch 31 charges the hydraulic accumulator 9 via the non-return valve 41 and the accumulator line 43, on the first control port 47 and on the second control port 35 of the drainage valve 37 the same pressures prevail in each case, specifically via the control line 33 from the input 17 and via the opened non-return valve 41 and the opened control valve 49 likewise from the input 17. The drainage valve 37 is a pressure compensator which is in the closed state when this constant pressure prevails on the control ports 47 and 35. The drainage valve 47 in this closed state does not form a drainage path from the input port 53 to an output port 55 that leads via a drain line 57 by way of the output 23 to the tank 25. Therefore, no drainage process takes place from the accumulator line 43, which is connected to the output 23 and the tank 25 via a pressure limitation valve 59 which forms an overpressure safeguard. A drainage valve that is likewise connected to the accumulator line 43 and that is manually opened only for maintenance purposes is designated as 61.

FIG. 4 conversely shows a state in which, likewise with the spring system blocked, the effective pressure in the hydraulic accumulator 9 is higher than the system pressure which is effective as dictated by operation on the piston side 7 of the lifting cylinder 5 and thus via the input 17 in the valve arrangement 11. To illustrate this in FIG. 4, in the part uppermost in the figure, the accumulator line 43 is indicated by the thick solid line and in its lower line part by the thick broken line. The non-return valve 41 is closed corresponding to the effective pressure that prevails in the hydraulic accumulator 9, which is higher than in the lifting cylinder 5.

Thus, there is higher effective pressure of the hydraulic accumulator 9 on the first control port 47 of the drainage valve 37 via the control valve 49 which is opened by the spring preload 52 and which is not energized, whereas the second control port 35 carries the lower effective pressure of the input 17 via the line branch 31.

As already mentioned, the drainage valve 37 has a pressure compensator which is shown symbolically in FIG. 7 and in the form of an operating diagram in FIG. 6. FIG. 8 shows a longitudinal section of one practical embodiment. As is apparent, it is a spool valve with slide valve piston 65 which is axially displaceable in the valve housing 63, shown in the closed position; this is caused by a hydraulic closing pressure which acts on the second control port 35, amplified by a mechanical preload force which is designated as 67 in FIGS. 6 and 7. The drainage valve 37 opens by a hydraulic opening pressure which is active on the first control port 47, assuming that the opening pressure on the slide valve piston 65 causes a higher opening pressure than the closing pressure which prevails on the control port 35, amplified by the preload force 67. In other words, the condition for the drainage valve 37 to open in order to form a drainage path from the input port 53 to the output port 55 and thus to the tank 25 is that it applies to the forces acting on the slide valve piston 65 that the closing force which results from the pressure on the second control port 35, plus the mechanical preload 67, is smaller than the opening pressure produced by the hydraulic pressure on the first control port 47. Therefore

F_{preload}+Fₚᵣₑₛₛᵤᵣₑ₃₅<Fₚᵣₑₛₛᵤᵣₑ₄₇

In the state depicted in FIG. 4, the pressure from the hydraulic accumulator 9 is drained until only a given, desired low pressure excess between the accumulator 9 and thus the input port 53 remains relative to the control port 35, i.e., the lifting cylinder 5, corresponding to the design of the pressure compensator which forms the drainage valve 37, specifically the effective piston areas and the effective preload force 67. This means that a drain process cannot lead to reducing the pressure in the hydraulic accumulator 9 to a value of zero.

In one advantageous exemplary embodiment, it can be provided here that the opening pressure difference dictated by the piston geometry and the preload force 67 be a pressure level of approximately 8 bar. FIG. 8 shows one exemplary embodiment in which two helical springs 69 and 71 act on a two-part slide valve piston 65 for producing the preload force 67 and preload the piston 65 into the illustrated closing position to the right in the figure, in which the input port 53 which is located on the axial end of the spool housing 53 which is on the right side in the figure is blocked relative to the output port 55. In addition to the preload force 67, the hydraulic pressure from the second control port 35 acts on the side of the piston 65, which is the left one in the figure. As the opening pressure for moving the piston 65 in the figure to the left, the right piston area is subjected to the opening pressure via the first control port 47.

To ensure that the pressure present on the input port 53 does not take effect as the effective control pressure which determines the behavior of the pressure compensator, it is important that the piston area which is indicated in FIG. 6 at 73 and which is bordered by the, control edges 75 and 77 between the ports 53 and 55 be considerably smaller than the effective piston areas 79, 79a, and 81 on the pressure spaces on the control port 47 or control port 35.

FIG. 5 relates to another state in which, at the input 19 of the valve arrangement 11, the higher effective pressure prevails, compared to the pressure at the input 17 or the pressure in the hydraulic accumulator 9. This operating state arises when a device runs up against an obstacle during operation of a machine with the spring system blocked. This can be the case, for example, when a mobile device, such as a wheel loader 1, with its shovel 3 runs up against an obstacle which forms an elevation, as a result of which the weight of the wheel loader 1 resting on the shovel 3 pushes the piston of the pertinent lifting cylinder 5 into the rod side 15, causing an overpressure to form on the rod side 15. This overpressure takes effect via the input 19 and the non-return valve 45 which opens in this state, as well as via the opened control valve 49 on the first control port 47 of the drainage valve 37 so that when the opening condition is met, i.e., a higher pressure on the port 53 compared to the control port 35, which is connected to the input 17 via the line branch 31, the drainage valve 37 opens, as a result of which in turn the drainage path to the tank 25 is opened, causing the pressure of the accumulator line 43 to be relieved. The higher pressure in the control port 47 ensures that the valve 37 is not in the blocking position.

As FIGS. 6 and 8 show in particular, the actual pressure compensator is formed by the helical spring 69 and by the effective pressure surfaces of the axially displaceable slide valve piston 65. The blocking piston made as a valve spool is in turn formed by the helical spring 71 and the effective piston area 81 of the indicated blocking piston part.

The piston designated as 65 in FIG. 6, as shown in FIG. 6, can be made in several parts in order in this way to form a non-return valve, i.e., the multipart design prevents opening of the valve seat 55 and unwanted backflow of the fluid into the system when a pressure prevails on the port 55 which is higher than that pressure which is formed by the preload forces of the helical springs 69 and 71 plus the effective compressive force by the pressure on the second control port 35. If this non-return valve function is to be omitted, the illustrated slide valve piston arrangement can also be made in one piece (not shown).

The invention thus ensures that the safety function is pressure compensation for all operating modes. It goes without saying that the construction of the drainage valve 37 as is shown using FIGS. 6 and 8 is not mandatory. Any valve construction whose operation corresponds to the aforementioned opening and closing conditions can be used. The construction of the two-part slide valve piston 65, which is depicted in FIG. 8 and in which construction the piston part to the right in this figure at the input port 53 forms a non-return valve which is loaded by the spring designated as 69 with low closing force, is not mandatory. In this construction, the closing spring designated as 71 forms the principal part of the preload which is designated as 67 in FIGS. 6 and 7 and which amplifies the closing force of the valve.

1. A device for compensating for hydraulic effective pressures in a hydraulic accumulator (9) and a hydraulic actuator (5) of a hydraulic system (11, 13), with a valve arrangement (27) for blocking a connection between the hydraulic actuator (5) and hydraulic accumulator (9) and with a control valve means (11) which effects pressure compensation when a predetermined difference of effective pressures is exceeded.

2. The device according to claim 1, characterized in that the valve arrangement has a directional valve (27) which in its release state establishes a direct fluid connection between the hydraulic actuator (5) and the hydraulic accumulator (9) and interrupts this fluid connection in its blocked state, and that the control valve means (11) can be activated depending on the transfer of the directional valve (27) into the blocked state and contains a drainage valve (37) which can be directed by a difference of effective pressures that exceeds the preset value into its release state in which a drainage path (57) which reduces the pressure difference toward the tank side (25) of the hydraulic system (11, 13) is formed.

3. The device according to claim 1, characterized in that the hydraulic actuator is at least one lifting cylinder (5) of a machine (1) whose piston side (7) which produces the lifting force and whose rod side (15) are connected to a control block (13) of the machine (1), and that the piston side (7) of the lifting cylinder (5) can be connected via the directional valve (27) to the hydraulic accumulator (9) and that the control valve means (11) has a connection (43) to the hydraulic accumulator (9) and fluid paths (41, 45) to the piston side (7) and to the rod side (15) of the lifting cylinder (5), which two fluid paths contain non-return valves (41, 45) which clear the path only from the lines of the lifting cylinder (5) which carry the higher effective pressure.

4. The device according to claim 1, characterized in that there is a drainage valve in the form of a pressure compensator (37) which in the release state clears the drainage path (57) which leads to the tank side (25) from the connection (43) to the hydraulic accumulator (9) and from the fluid path (41, 45) which has been cleared in each case and which leads to the lifting cylinder (5).

5. The device according to claim 1, characterized in that the pressure compensator (37) has an input port (53) which is connected to the hydraulic accumulator (9), an output port (55) which is connected to the tank (25), a first control port (47) for the supply of an unblocking pressure, and a second control port (35) for the supply of a closing pressure.

6. The device according to claim 1, characterized in that the second control port (35) is connected to the piston side (7) of the lifting cylinder (5).

7. The device according to claim 1, characterized in that a preload (67) which amplifies the action of the closing pressure on the second control port (35) takes effect on the pressure compensator (37).

8. The device according to claim 1, characterized in that the pressure compensator (37) has a slide valve piston (65) which for its displacement into the blocking position on one piston area (81) can be loaded both with the closing pressure prevailing on the second control port (35) and also with the force of a preload spring (69, 71), and that the other piston area (79a) can be loaded with the unblocking pressure which prevails on the first control port (47).

9. The device according to claim 1, characterized in that the effective piston area (81) of the slide valve piston (65) which borders the second control port (35) is greater than the effective piston area (79) which borders the first control port (47).

10. The device according to claim 1, characterized in that the input port (53) of the pressure compensator (37) on the end of the slide valve piston (65) opposite the preload spring (69, 71) is formed by the axial end-side opening of the spool housing (63) and that there is one control edge (77, 75) at a time on the assigned end region of the slide valve piston (65) and on the spool housing (63) between its end-side opening and the first control port (47) which is offset axially to the inside in the housing (63).

11. The device according to claim 1, characterized in that the directional valve (27) is mechanically preloaded into the release state and can be hydraulically directed into the blocking state.

12. The device according to claim 1, characterized in that a control valve (49) in the opening state connects the fluid path (41, 45) of the control valve means (11) which carries the higher effective pressure to the first control port (47) of the pressure compensator (37) and delivers to the directional valve (27) the hydraulic pressure which blocks it.
